(19) United States
(12) Patent Application Publication
(10) Pub. No.: US 2002/0005835 A1
(43) Pub. Date: Jan. 17, 2002

(54) Computer mouse with metallic exterior

(76) Inventors: Leonard Florence, Chestnut Hill, MA (US); Melvin L. Levine, Boston, MA (US)

Correspondence Address: ROBERT J. SILVERMAN, Fish & Richardson P.C., 225 Franklin Street, Boston, MA, 02110-2804, US

(21) Appl. No.: 09/887,217

(22) Filed: Jun. 22, 2001

Related U.S. Application Data
(60) Provisional application No. 60/214,695, filed on Jun. 27, 2000.

(51) Int. Cl. G09G 5/08

(52) U.S. Cl. 345/163

(57) ABSTRACT

A computer mouse has a metallic exterior surface. The metallic surface may be, for example, a cover sheath or cladding. Preferably, the metallic exterior surface is capable of being engraved or etched, so that words, symbols, or other markings may be inscribed therein. Alternatively, the metallic exterior may be embossed with words, symbols, or other markings.

### BACKGROUND

The invention relates to a computer mouse. A typical computer mouse is a hand-operated device that sends control signals to a computer, for example through a cable. A user generates control signals by manipulating the mouse. For example, control signals may be generated by moving the housing against a surface, thereby causing the movement of a rolling member that protrudes from the bottom of the mouse. Additionally or alternately, the user may depress one or more actuation members that are part of the housing. The actuation members are generally located on a region of the mouse accessible to the user's fingers. Typically, there are no actuation members on a broad region of the housing that fits beneath the user's palm.

### SUMMARY

The invention, in one aspect, features a computer mouse having a metallic exterior surface. The metallic surface may be, for example, a cover, sheath, or cladding.

Preferably, the computer mouse has a metallic cover that is attached to at least particular portions of a housing of the computer mouse. The metallic cover may be attached to only particular surfaces of the housing. Alternatively, the cover may encompass the entire housing. Preferably, the housing is made of plastic and the metallic cover is connected with an adhesive to upper and side surfaces of the housing. However, the metallic cover may also be bolted, snap-fitted, friction-fitted, bonded, laminated, or attached to the housing in any other desired manner. Separate pieces of the metallic cover may be sized and shaped to conform to actuation members of the computer mouse and to a broad region of the mouse beneath the user's palm. The metallic cover may be removably attached to the housing. Such a removable cover may be replaced with similar or different cover, in order to alter the appearance or handling characteristics of the computer mouse, or to replace a worn, dirty, or damaged cover.

In an alternative embodiment, at least a portion of the computer mouse housing itself is made of metallic material. In such embodiments, there need not be a separate metallic cover that must be attached to the housing.

Preferably, the metallic exterior is made of a metal. Exemplary materials include silver, silver-plated metal, gold, gold-plated metal, platinum, steel, aluminum, copper, brass, bronze, and pewter. Any other suitable metallic material may be used, including plastics that have a reflective or metallic appearance. Preferably, the metallic exterior is also capable of being engraved or etched, so that words, symbols, or other markings may be inscribed therein. Alternatively, the metallic exterior may be embossed with words, symbols, or other markings. Such techniques can be used to make a durable inscription on the metallic exterior.

The metallic exterior may have a variety of different surface textures, in accord with preferences for the appearance and the tactile experience of manipulating the device. For example, the metallic exterior may be polished, so that it is smooth and highly reflective. Alternatively, the metallic exterior may have a brushed surface, creating a more dull appearance. The metallic exterior may also be knurled, stippled, grooved, or have any other desired texture for improving the grip and performance of the device.

The metallic exterior may have any desired thickness, in accord with preferences for size, weight, durability, and handling characteristics of the computer mouse.

One or more of the following advantages may be provided by one or more aspects of the invention.

The device's metallic exterior creates a surface that can be engraved, etched, or embossed, thereby permitting the inscription of text or other markings. Inscribing the device in this manner permits a user or owner to identify or personalize a computer mouse with, for example, a name or corporate logo. The capacity to make inscriptions on the device enhances its utility as a gift item to commemorate a graduation, wedding, bar mitzvah, or the like. Engraved silver items, for example, are particularly desirable as gifts or momentos because they add durable inscriptions to valuable items of metalwork.

The choice of materials and surface textures for the metallic exterior gives the device a particular desired visual appearance and tactile feel.

The metallic exterior may add size and mass to the computer mouse, thereby improving the handling characteristics of the device.

Devices having a removable metallic cover may be equipped with any one of a variety of different covers, in order to alter the appearance and handling characteristics of the device.

Other advantages and features will become apparent from the following description.

### DESCRIPTION OF DRAWINGS

FIG. 1 is a perspective view of a computer mouse having a metallic cover.

FIG. 2 is a plan view of a metallic cover for a computer mouse.

FIG. 3 is a side elevation view of the metallic cover of FIG. 2.

FIG. 4 is a partial sectional view of the metallic cover of FIG. 2 taken along the line IVIV.

FIG. 5 is a partial sectional view of the metallic cover of FIG. 2 taken along the line V-V.

### DETAILED DESCRIPTION

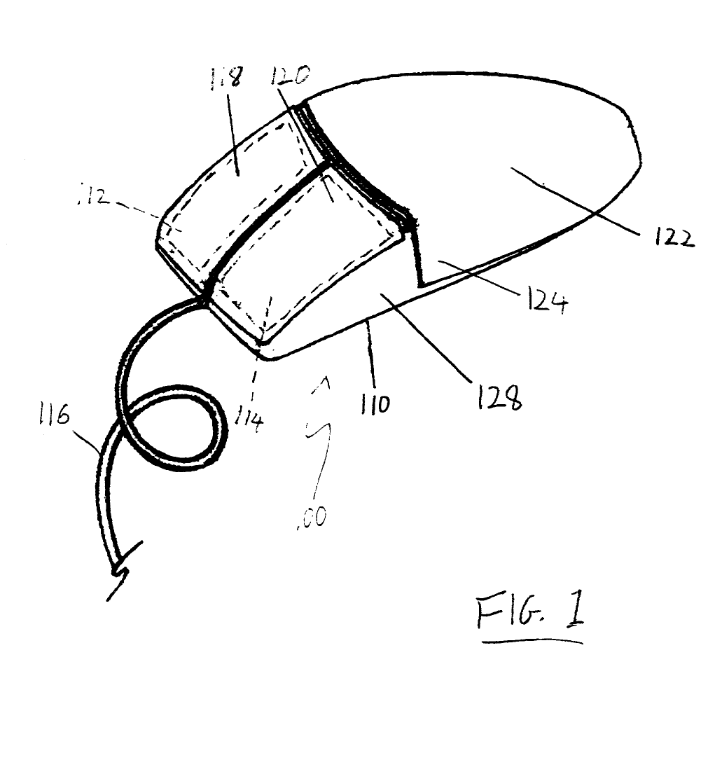

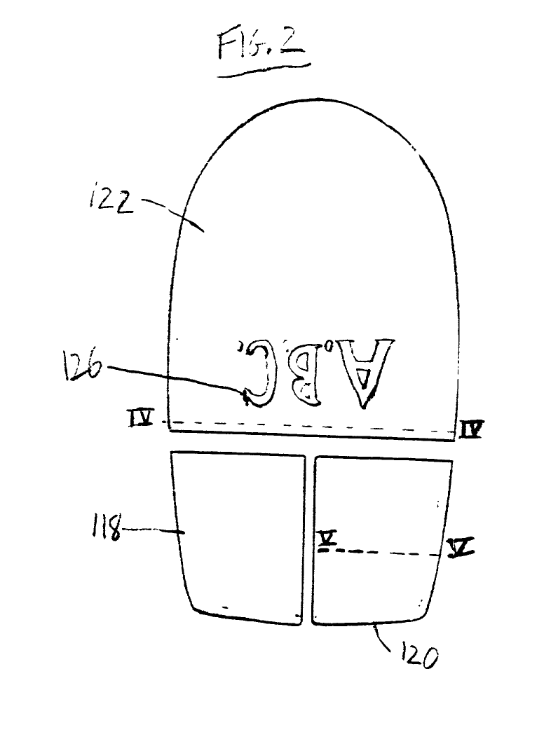

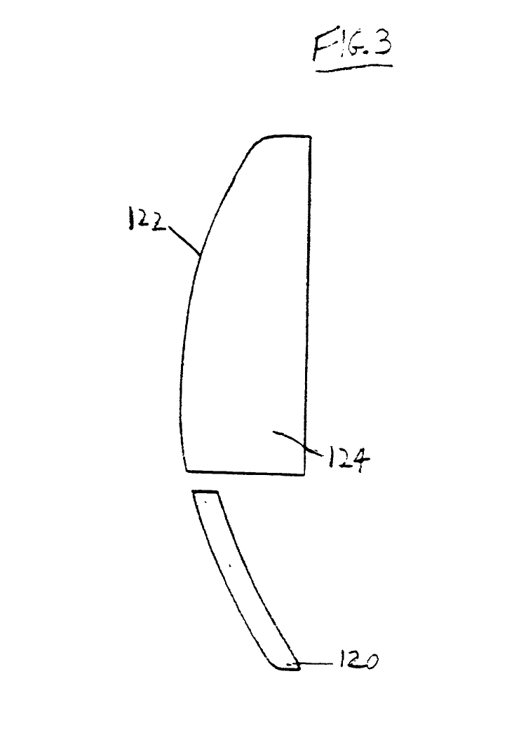

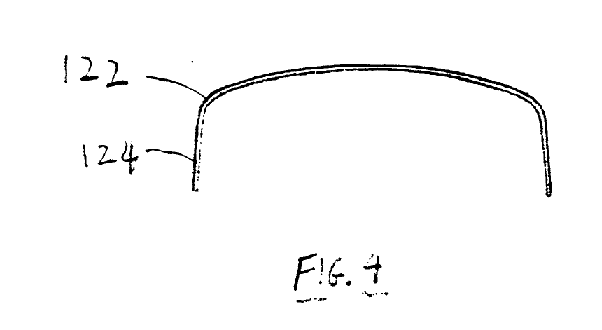

Referring to FIGS. 1-5 there is shown a computer mouse 100 having housing 110 with first actuation member 112 and second actuation member 114 (both shown in phantom), cable 116, first cover member 118, second cover member 120, and third cover member 122.

Housing 110 and its first and second actuation members 112, 114 are made of plastic. Actuation members 112, 114 are independently moveable and are capable of being depressed by a user in order to generate control signals for a computer (not shown).

First, second, and third cover members 118, 120, and 122 are shaped to conform to the external configuration of housing 110. Cover members 118, 120, and 122 are bonded to housing 110 with adhesive. Cover members 118, 120, and 122 are made of polished sterling silver having thickness, hardness, and malleability that permits it to be engraved, for example with inscription 126. Preferably, cover members 118, 120, and 122 are 0.025 inches thick, although any suitable thickness may be used. As seen in FIG. 1, first and second cover members 118, 120 substantially conceal first and second actuation members 112, 114, respectively. However, as seen in FIGS. 1, 3 and 4, third cover member 122 includes side panels 124 that extend downward partially along the sides of housing 110, leaving portion 128 of housing exposed. The side panels thus do not interfere with the movement of the mouse.

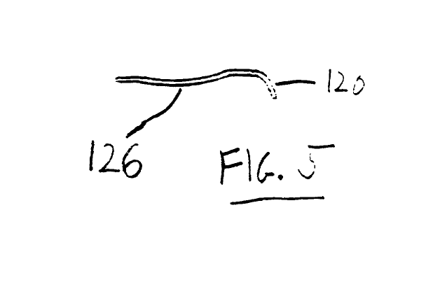

First cover member 118 is bonded to first actuation member 112 and second cover member 120 is bonded to second actuation member 114 so that cover members 118, 120 move with respective actuation members 112, 114 when cover members 118, 120 or actuation members 112, 114 are depressed. As seen in FIG. 5, second cover member 120 defines contour depression 126 to permit comfortable manipulation by a user's finger. First cover member 118 may be similarly contoured.

One embodiment of the invention has been described. Nevertheless, it will be understood that various modifications may be made without departing from the spirit and scope of the invention. For example, the cover members may be designed so as to cover substantially all of the mouse housing, rather than leaving an area exposed. Additionally, the mouse may be a wireless mouse that does not include a cable. Accordingly, other embodiments are within the scope of the invention.

What is claimed is:

1. A computer mouse comprising:
a housing comprising a plastic material and further comprising first and second actuation members;
a cover attached to outer portions of said housing, said cover comprising a metallic material.

2. The computer mouse of claim 1 wherein distinct first and second cover members are attached to said first and second actuation members.

3. The computer mouse of claim 1 wherein said cover leaves exposed regions on sides and an undersurface of said housing.

4. The computer mouse of claim 1 wherein said cover is bonded to said housing with an adhesive.

5. The computer mouse of claim 1 wherein said cover is removably fitted to said housing.

6. The computer mouse of claim 1 wherein said cover is friction-fitted to said housing.

7. The computer mouse of claim 1 wherein said metallic cover is made of silver-plated metal.

8. The computer mouse of claim 1 wherein said metallic cover is made of sterling silver.

9. The computer mouse of claim 1 wherein said metallic cover comprises gold.

10. The computer mouse of claim 1 wherein said metallic cover is engraveable.

11. The computer mouse of claim 1 wherein said metallic cover has been engraved with an inscription.

12. A wireless computer mouse comprising:
a housing comprising a plastic material and further comprising first and second actuation members;
a cover attached to outer portions of said housing, said cover comprising a metallic material.

13. The wireless computer mouse of claim 12 wherein distinct first and second cover members are attached to said first and second actuation members.

14. The wireless computer mouse of claim 12 wherein said cover leaves exposed regions on sides and an undersurface of said housing.

15. The wireless computer mouse of claim 12 wherein said cover is bonded to said housing with an adhesive.

16. The wireless computer mouse of claim 12 wherein said cover is removably fitted to said housing.

17. The wireless computer mouse of claim 12 wherein said cover is friction-fitted to said housing.

18. The wireless computer mouse of claim 12 wherein said metallic cover is made of silver-plated metal.

19. The wireless computer mouse of claim 12 wherein said metallic cover is made of sterling silver.

20. The wireless computer mouse of claim 12 wherein said metallic cover comprises gold.

21. The wireless computer mouse of claim 12 wherein said metallic cover is engraveable.

22. The wireless computer mouse of claim 12 wherein said metallic cover has been engraved with an inscription.

23. A computer mouse comprising
a housing comprising a plastic material and further comprising first and second actuation members;
a cover attached to outer portions of said housing, said cover comprising an engraveable metallic material;
wherein distinct first and second cover members are attached to said first and second actuation members.

24. The computer mouse of claim 23 wherein said cover leaves exposed regions on an undersurface of said housing.

25. The computer mouse of claim 24 wherein said cover leaves exposed regions on sides and on an undersurface of said housing.

26. The computer mouse of claim 24 wherein said cover is bonded to said housing with an adhesive.

27. The computer mouse of claim 24 wherein said cover is removably fitted to said housing.

28. The computer mouse of claim 24 wherein said cover is friction-fitted to said housing.

29. The computer mouse of claim 24 wherein said metallic cover comprises silver.

30. The computer mouse of claim 29 wherein said metallic cover is made of silver-plated metal.

31. The computer mouse of claim 29 wherein said metallic cover is made of sterling silver.

32. The computer mouse of claim 24 wherein said metallic cover comprises gold.

33. The computer mouse of claim 24 wherein said metallic cover has been engraved with an inscription.

34. The computer mouse of claim 29 wherein said metallic cover has been engraved with an inscription.

35. The computer mouse of claim 30 wherein said metallic cover has been engraved with an inscription.

36. The computer mouse of claim 31 wherein said metallic cover has been engraved with an inscription.

37. The computer mouse of claim 32 wherein said metallic cover has been engraved with an inscription.

38. The computer mouse of claim 33 wherein said computer mouse is a wireless computer mouse.
